(19) United States
(12) Patent Application Publication
(10) Pub. No.: US 2006/0164743 A1
(43) Pub. Date: Jul. 27, 2006

(54) Method for copying source data from a source hard disk to multiple target hard disks

(76) Inventor: Ming-Jang Liu, Tanzih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/205,057

(22) Filed: Aug. 17, 2005

(30) Foreign Application Priority Data
Jan. 26, 2005 (TW) 94102380

(51) Int. Cl. G11B 5/86

(52) U.S. Cl. 360/15

(57) ABSTRACT

A method for one-to-multiple copying of data storage medium is provided, applicable to a hard disk copying system to copy the source data in a source hard disk to a plurality of target hard disks. The method includes steps of preparing a source hard disk and a plurality of target hard disks, and placing the target hard disks to hard disk receiving slots of the hard disk copying system; detecting and recording the number and addresses of the target hard disks; and copying the source data in the source hard disk to the target hard disks one by one. The method further includes steps of data compression and decompression to accelerate the data copying process.

### FIELD OF THE INVENTION

The present invention relates to a method for data copying and, more particularly, to a method for data copying of data storage medium, such as hard disk drive, using a hard disk copy system with a plurality of hard disk receiving slots.

### BACKGROUND OF THE INVENTION

As the computer technology improves and the data copying of storage medium is a part of computer manufacturing, a hard disk copying system with a plurality of hard disk receiving slots is used in computer manufacturing. With the hard disk copying system, the data stored in a hard disk can be copied to the hard disks placed in the hard disk receiving slots.

The structure of the current hard disk copying system includes a system hard disk in one of the hard disk receiving slots, and a source hard disk in another hard disk receiving slot. The remaining hard disk receiving slots are for placing a plurality of target hard disk for copying data to. With the operating system on the system hard disk, the system will copy the data on the source hard disk to the target hard disks.

However, although the current technology can copy the data in the data storage medium, the efficiency of the data copying depends on the capacity of the source data hard disk. That is, when the capacity of the source hard disk is doubled, the time required to copy the data to the target hard disks is sometimes more than doubled. For example, a current system can copy data to five target hard disks simultaneously. If a quick copy mode is selected, copying a 36 GB hard disk takes 30 minutes, and copying a 72 GB hard disk takes 72 minutes.

As the capacity of the hard disks is constantly increasing and the number of the hard disks to be copied is large, the conventional technique used in current hard disk copying systems may pose as a hurdle to the manufacturing efficiency. It is imperative to provide a fast and flexible data storage medium copying method to solve the aforementioned efficiency problem.

### SUMMARY OF THE INVENTION

The present invention is provided to overcome the aforementioned drawback of the conventional technique. The primary object of the present invention is to provide a fast and flexible data storage medium copying method to solve the hard disk copying efficiency problem in the current computer manufacturing process.

Another object of the present invention is to provide a method for one-to-multiple copying of data storage medium, which is applicable to a hard disk copying system for copying the source data in a source hard disk to a plurality of target hard disks efficiently to overcome the constrained imposed by the capacity of the hard disk in a conventional hard disk copying system.

Yet another object of the present invention is to provide a method for one-to-multiple copying of data storage medium with compression and decompression functions. The source data in the source hard disk can be compressed to reduce the size of the data to be copied, and the compressed data can be decompressed during the copying process so that the data copying can be executed in less time.

To achieve the aforementioned objects, the present invention provides a method including the following steps. First, the source hard disk and a plurality of target hard disks are placed in the hard disk receiving slots of the hard disk copying system. Then, the control program of the present invention will detect and record the number of the target hard disks and their address, followed by the hard disk copying step, in which the present invention selects a target hard disk, formats the target hard disk according to the sectors and format of the source hard disk and copies the data on the source hard disk to the selected target hard disk. The above step is repeated for each target hard disk to complete the hard disk copying. More specifically, the time required for copying by the techniques employed by the present invention depends on the sector configuration, file size, and the rotation speed of the hard disk, instead of the capacity of the hard disk.

Preferably, the method of the present invention can further use a data compression technique to accelerate the speed of copying. In addition, the present invention can copy the data in the source hard disk to a data buffer during the copying, and then copy the data to a target hard disk sequentially until the copying to the target hard disk is complete. This process can be repeated until each of the target hard disks completes the copying of data in the buffer.

In comparison with the conventional techniques, the present invention overcomes the problems of inefficiency and inflexibility of the conventional copying method of data storage medium, and meets the demands of speedy manufacturing of computers. The present invention also overcomes the limitation of the hard disk capacity in a conventional copying method. And the inclusion of compression and decompression functions in the present invention further reduces the time required for the data copying.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a perspective view of a hard disk copying system according to the present invention;

FIG. 2 shows a schematic view of a diagram of the hard disk copying system according to the present invention;

FIG. 3 shows a control flowchart of a first embodiment of the present invention; and

FIG. 4 shows a control flowchart of a second embodiment of the present invention.

### DETAILED DESCRIPTION OF THE BEST MODE FOR CARRYING OUT THE PRESENT INVENTION

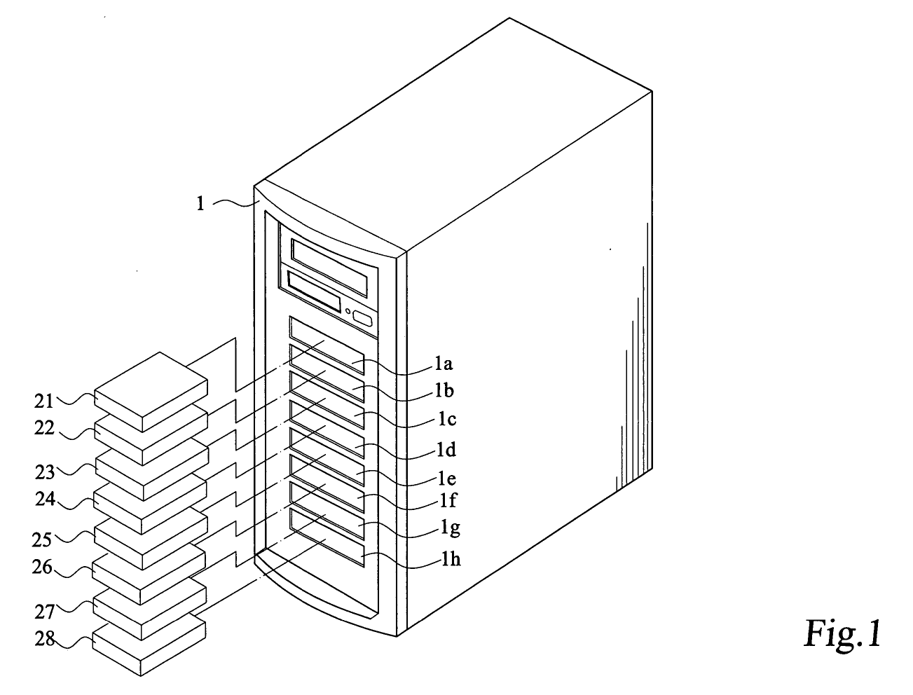

With reference to the drawings and in particular to FIG. 1, a hard disk copying system constructed in accordance with the present invention, generally designated with reference numeral 1, comprises a plurality of hard receiving slots, which in the embodiment illustrated include eight hard disk receiving slots 1a, 1b, 1c, 1d, 1e, 1f, 1g, 1h. Each hard disk receiving slot 1a, 1b, 1c, 1d, 1e, 1f, 1g, 1h can receive a removable hard disk. The first hard disk receiving slot 1a receives a system hard disk 21, the second hard disk receiving slot 1b receives a source hard disk 22, and the remaining hard disk receiving slots 1c, 1d, 1e, 1f, 1g, 1h receive a plurality of target hard disks 23, 24, 25, 26, 27, 28 for copying data into.

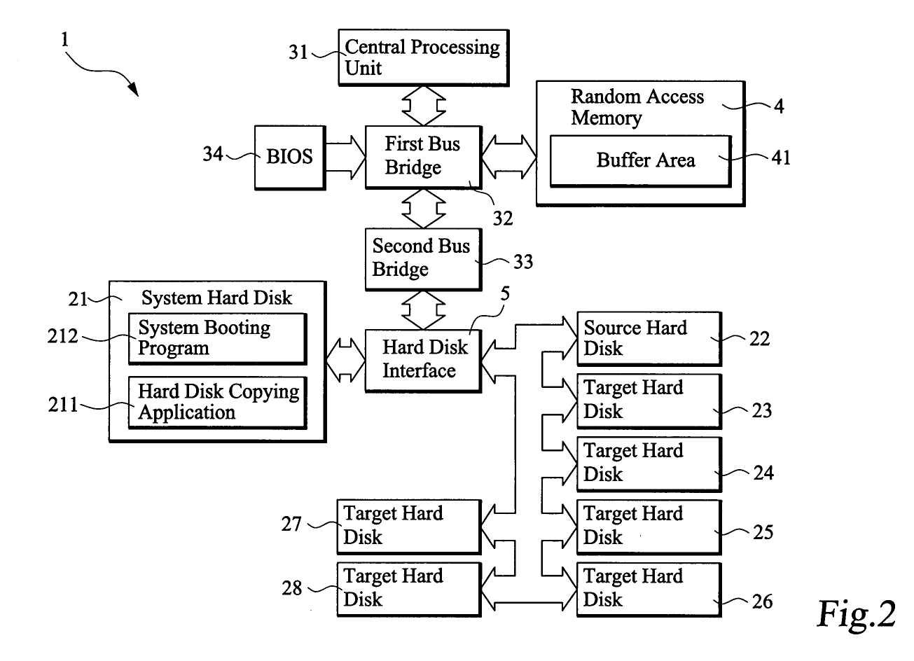

Also referring to FIG. 2, which shows a schematic view of a hard disk copying system used in the present invention, the hard disk copying system 1 comprises a central processing unit (CPU) 31, a first bus bridge 32, a second bus bridge 33, and a BIOS 34. The hard disk copying system 1 also includes a random access memory (RAM) 4, in which a buffer area 41 can be configured for temporarily storing the source data.

The second bus bridge 33 is connected to a hard disk interface 5, such as IDE hard disk interface, for connecting the system hard disk 21, the source hard disk 22 and the target hard disks 23, 24, 25, 26, 27, 28. The system hard disk 21 is installed with a hard disk copying application 211 of the present invention. The system hard disk 21 is also installed with a system booting program 212 and an operation system, such as Windows®. When the computer is booted, the operating system is activated so that the computer runs under the operating system.

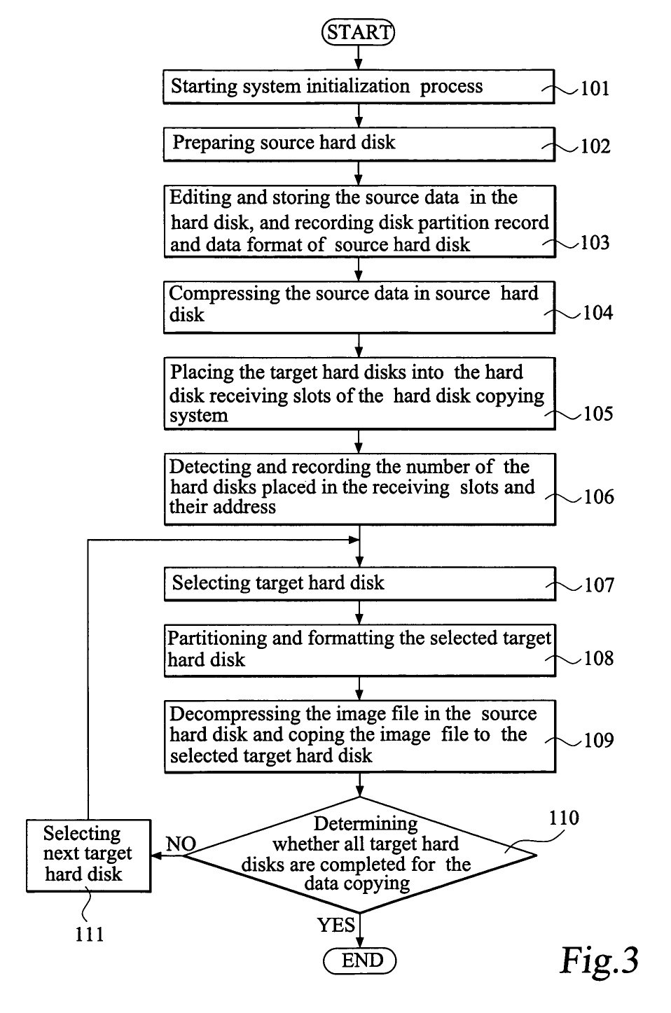

Also referring to FIG. 3, which shows a control flowchart of a first embodiment of the present invention, the following description of the flowchart in FIG. 3 also refers to the schematic view in FIG. 2.

First, when the hard disk copying system 1 is booted, the hard disk copying system 1 starts system initialization process (step 101) to complete all the system activation, initialization and start the device drivers. In step 102, the user prepares the source hard disk 22. The user can edit, store the data in the hard disk, and record the disk partition record and data format of source hard disk 22 (step 103).

In the preferred embodiment of the present invention, the source hard disk 22 may comprise at least an empty sector record which can be ignored during the copying of the source data in the source data had disk 22 to the target hard disk in order to accelerate the copying.

Preferably, the source data in source hard disk 22 can be compressed to generate a compressed image file (step 104).

In step 105, the target hard disks 23, 24, 25, 26, 27, 28 are placed into the hard disk receiving slots 1c, 1d, 1e, 1f, 1g, 1h of the hard disk copying system 1 respectively. In step 106, the hard disk copying system detects and records the number of the hard disks placed in the receiving slots and their address.

In step 107, the hard disk copying application 211 selects the target hard disk 23. In step 108, the hard disk copying application 211 partitions and formats the selected target hard disk 23.

In step 109, the image file in the source hard disk 22 is decompressed and copied to the selected target hard disk 23, until the source data in the source hard disk 22 is completely copied to the target hard disk 23.

After completing data copying to the hard disk 23, the present invention repeats steps 107-109 for the next target hard disk to copy the source data. Step 110 is to determine whether all target hard disks are completed for the data copying. If not, the next target hard disk is selected (step 111) for data copying; otherwise, the process terminates and the one-to-multiple copying of data storage medium is complete.

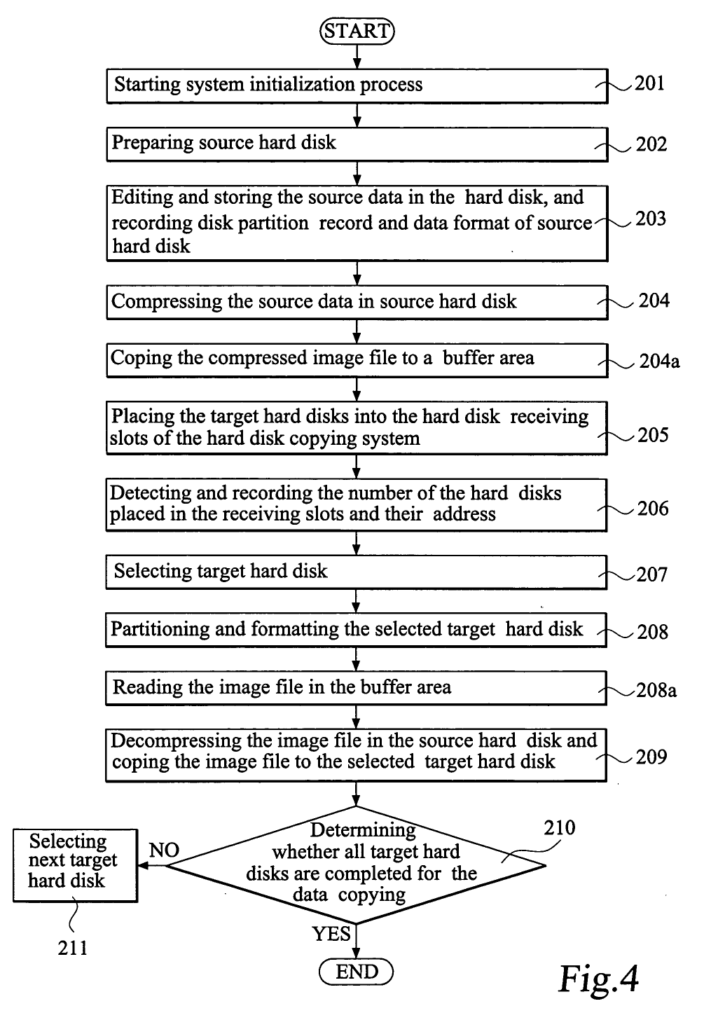

FIG. 4 shows a control flowchart in accordance with a second embodiment of the present invention. The majority of the steps in this flowchart are identical to those in the first embodiment. But this embodiment includes a step of copying the data to a buffer area.

First, when the hard disk copying system 1 is booted, the hard disk copying system 1 starts system initialization process (step 201) to complete all the system activation, initialization and start the device drivers. In step 202, the user prepares the source hard disk 22. The user can edit, store the data in the hard disk, and record the disk partition record and data format of source hard disk 22 (step 203).

In the preferred embodiment of the present invention, the source hard disk 22 may comprise at least an empty sector record which can be ignored during the copying of the source data in the source data had disk 22 to the target hard disk in order to accelerate the copying.

Preferably, the data in the source hard disk 22 can be compressed to generate a compressed image file (step 204). In this embodiment, the compressed image file is copied to buffer area 41 of RAM 4 (step 204a).

In step 205, the target hard disks 23, 24, 25, 26, 27, 28 are placed into the hard disk receiving slots 1c, 1d, 1e, 1f, 1g, 1h of the hard disk copying system 1 respectively. In step 206, the hard disk copying system detects and records the number of the hard disks placed in the receiving slots and their address.

In step 207, the hard disk copying application 211 selects the target hard disk 23. In step 208, the hard disk copying application 211 partitions and formats the selected target hard disk 23.

In step 208a, the image file in the buffer area 41 of the RAM 4 is read. In step 209, the read compressed image file is decompressed and copied to the selected target hard disk 23, until the source data in the source hard disk 22 is completely copied to the target hard disk 23.

After completing data copying to the hard disk 23, the present invention repeats steps 207-209 for the next target hard disk to copy the data. Step 210 is to determine whether all target hard disks are completed for the data copying. If not, the next target hard disk is selected (step 211) for data copying; otherwise, the process terminates and the one-to-multiple copying of data storage medium is complete.

While the invention has been described in connection with what is presently considered the best mode for carrying out the present invention, it is to be understood that the invention is not to be limited to what is disclosed above, but on the contrary, is intended to cover various modifications and equivalent arrangement included within the spirit and scope of the appended claims.

What is claimed is:

1. A method for copying a source data of a source hard disk coupling to a hard disk copying system with a plurality of hard disk receiving slots to a plurality of target hard disks, comprising steps of:
(a) preparing the source hard disk containing at least a disk partition record, a data format of the source hard disk and the source data to be copied;
(b) preparing a plurality of target hard disks, and placing the target hard disks to the hard disk receiving slots of the hard disk copying system;
(c) detecting and recording the number and addresses of the target hard disks;
(d) selecting a target hard disk;
(e) partitioning and formatting the selected target hard disk according to the disk partition record, the data format of the source hard disk;
(f) copying source data in the source hard disk to the selected target hard disk; and
(g) repeating steps (d) to (f) for copying the source data to each target hard disk.

2. The method as claimed in claim 1, wherein step (f) further comprises a step of copying the source data of in the source hard disk to a buffer area in the hard disk copying system.

3. The method as claimed in claim 2, wherein the data in the target hard disk is copied from the source data from the buffer area in the hard disk copying system.

4. The method as claimed in claim 2, wherein the source data in the source hard disk is further compressed before copying to the buffer area.

5. The method as claimed in claim 4, wherein the source data in the buffer area is decompressed before copying to the target hard disk.

6. The method as claimed in claim 1, wherein the source hard disk comprises at least an empty sector record which is ignored during the copying of the source data to the target hard disk.

7. A method for copying a source data of a source hard disk coupling to a hard disk copying system with a plurality of hard disk receiving slots to a plurality of target hard disks, the method comprising the steps of:
(a) preparing the source hard disk containing at least a disk partition record, a data format of the source hard disk and the source data to be copied, the source data being compressed into an image file;
(b) preparing a plurality of target hard disks, and placing the target hard disks to the hard disk receiving slots of the hard disk copying system;
(c) detecting and recording the number and addresses of the target hard disks;
(d) selecting a target hard disk;
(e) partitioning and formatting the selected target hard disk according to the disk partition record, the data format of the source hard disk;
(f) decompressing the compressed image file in the source data hard disk;
(g) copying the decompressed image file to the selected target hard disk; and
(h) repeating steps (d) to (g) for copying the source data to each target hard disk.

8. The method as claimed in claim 7, wherein step (g) further comprises a step of copying the compressed image file in the source hard disk to a buffer area in the hard disk copying system.

9. The method as claimed in claim 8, wherein the data in the target hard disk is copied from the compressed image file from the buffer area in the hard disk copying system.

10. The method as claimed in claim 7, wherein the source hard disk comprises at least an empty sector record which is ignored during the copying of the image file to the target hard disk.
